(19) United States
(12) Patent Application Publication
(10) Pub. No.: US 2003/0214277 A1
(43) Pub. Date: Nov. 20, 2003

(54) Circuit and method for providing an output current with a prescribed temperature coefficient

(75) Inventor: Reinhard Reimann, Heilbronn (DE)

Correspondence Address: FASSE PATENT ATTORNEYS, P.A., P.O. BOX 726, HAMPDEN, ME, 04444-0726, US

(73) Assignee: ATMEL Germany GmbH, Heilbronn (DE)

(21) Appl. No.: 10/439,934

(22) Filed: May 16, 2003

(30) Foreign Application Priority Data
May 18, 2002 (DE) 102 22 307.6

(51) Int. Cl. G05F 3/04

(52) U.S. Cl. 323/312

(57) ABSTRACT

A circuit includes two internal current sources or sinks coupled together by a coupling element, which may be a direct junction as a summing element or a current mirror as a subtracting element. In an associated method, the currents of the two internal current sinks or sources are summed or subtracted by the coupling element to form an output current. The magnitudes and/or temperature coefficients of the two internal currents differ from one another. The temperature coefficient of the output current is determined by the addition or subtraction of the internal currents, and can be selected as desired, simply and economically, by appropriately selecting the temperature coefficients of the internal currents and the adding or subtracting carried out by the coupling element. The output current can even have a negative temperature coefficient, based on economical internal components having only positive temperature coefficients.

### PRIORITY CLAIM

This application is based on and claims the priority under 35 U.S.C. §119 of German Patent Application 102 22 307.6, filed on May 18, 2002, the entire disclosure of which is incorporated herein by reference.

### FIELD OF THE INVENTION

The invention relates to a method for producing an output current having a prescribed temperature coefficient, and to a circuit arrangement including a current sink or a current source for carrying out such a method.

### BACKGROUND INFORMATION

A current source circuit and corresponding method of the above mentioned general type are known from U.S. Pat. No. 6,265,857 (Demsky et al.). The known current source circuit according to this reference includes a first current sink having an output current with a positive temperature coefficient and a second current sink having an output current with a negative temperature coefficient, as well as a mixer to which a control voltage is applied. The mixer proportionally mixes the two currents from the two current sinks dependent on the control voltage that is applied to the mixer. The resulting overall or mixed output current generated by the mixer thus has a temperature coefficient that is determined by the mixing ratio of the two currents of the two current sinks by the mixer. In this context, the value range of the possible resulting temperature coefficients of the output current of the mixer is determined by the difference between the positive and negative temperature coefficients of the two current sinks. It is disadvantageous in the known circuit arrangement and method, that the resulting temperature coefficient of the output current of the mixer can only be varied within the above mentioned limited value range, and further that the circuit requires a current mixer as well as a variable control voltage for controlling the mixer. A further disadvantage involves the complexity and expense arising because the circuit must include a first current sink with a positive temperature coefficient and a second current sink with a negative temperature coefficient.

Electronic circuits typically exhibit a temperature drift, i.e. a temperature dependent variation of the performance characteristics such as the current, dependent on the momentary existing operating temperature of the circuit, due to the temperature dependence of the electrical characteristics of the various components of these circuits, for example resistors and transistors. In some types of circuit arrangements, it is desirable to avoid or suppress a resultant temperature drift. For example, especially in voltage regulating circuits in which a current sink with a resistor is used as an internal voltage reference, a temperature drift should be suppressed to the extent possible. On the other hand, when using current sinks in compensation circuits for high frequency applications, it is actually necessary to achieve a certain prescribed temperature coefficient, in order to compensate an undesirable temperature dependence exhibited by an electronic circuit in such an application.

### SUMMARY OF THE INVENTION

In view of the above, it is an object of the present invention to provide a method for producing an output current with a prescribed temperature coefficient (defining the temperature dependent variation of the current magnitude), whereby the value of the temperature coefficient can be specified or fixed in a simple and economical manner. Another object of the invention is to provide a circuit arrangement for carrying out such a method. The invention further aims to avoid or overcome the disadvantages of the prior art, and to achieve additional advantages, as apparent from the present specification.

The above objects have been achieved according to the invention in a method for producing an output current with a prescribed temperature coefficient by means of a first current source or current sink that provides a first internal current with a first temperature coefficient, and a second current source or current sink that provides a second internal current with a second temperature coefficient. Further according to the invention, the current magnitudes and/or the temperature coefficients of the two internal currents differ from one another, and the two internal currents are added together or subtracted from one another to thereby form the resulting overall output current.

The above objects have further been achieved according to the invention in a current supply circuit for carrying out the above mentioned method, comprising a first current source or current sink, a second current source or current sink, and a coupling element. The first current source or current sink has its first current terminal connected with a first input of the coupling element, while the second current source or current sink has its second current terminal connected with a second input of the coupling element. Furthermore, an output of the coupling element is connected with an output of the overall current supply circuit arrangement. The coupling element effectively adds together the two internal currents or subtracts one of the internal currents from the other to form the overall output current at the circuit output. Preferably, the circuit arrangement uses first and second current sinks, and the coupling element may especially be embodied as a current mirror, which subtracts one of the internal currents from the other.

The basic principle of the invention is to form an output current having a prescribed temperature coefficient by combining or coupling the respective currents of two current sinks or current sources that respectively have any desired temperature coefficients, for example both having positive temperature coefficients or both having negative temperature coefficients, or having coefficients of different sign, or one of the current sinks or sources having a temperature coefficient essentially equal to zero. The overall output current is formed or produced in that the first internal current having a first temperature coefficient provided by the first current sink or first current source is added together with or subtracted from the second internal current having a second temperature coefficient provided by the second current sink or current source, or vice versa. The magnitudes of the two circuit-internal currents of the two current sinks or sources, and/or the temperature coefficients thereof, are different from one another.

The first and second current sources or sinks respectively have prescribed, but arbitrary, i.e. any desired positive or negative, temperature coefficients. Advantageously according to the invention, the coupling of the two currents of the first and second current sources or sinks with the prescribed, but arbitrarily choosable temperature coefficients, makes it possible to specify or fix the resulting overall temperature coefficient of the output current of the current supply circuit, arbitrarily or with any desired value, by summing or by subtracting the two currents relative to each other. Thereby the currents must simply have suitable temperature coefficients to achieve the desired resulting temperature coefficient when the currents are added or subtracted. It is especially possible according to the invention, for example, to achieve a resulting negative temperature coefficient for the output current, using two positive or non-negative temperature coefficients of the two internal currents, and vice versa (throughout this specification the term “non-negative” encompasses zero and positive values). For example, this can be achieved by subtracting one internal current from the other.

Experiments conducted by the present applicant have demonstrated that it is especially advantageous if the first temperature coefficient deviates sharply or significantly from the second temperature coefficient, or especially when one of the two internal currents has essentially no temperature dependence, i.e. a temperature coefficient equal to zero or negligibly close to zero (throughout this specification, the phrase “negligibly close to zero” means within a tolerance or accuracy range around zero so that the actual value can be regarded as zero within the required degree of tolerance or accuracy of the circuit). Furthermore, the magnitude of the resulting temperature coefficient of the output current of the overall current supply circuit is dependent on the ratio of the current value of the first current sink or source relative to the current value of the second current sink or source.

Other experiments conducted by the present applicant have shown that the temperature drift of a circuit, for example such as a received signal strength indicator (RSSI) circuit, may easily be compensated, or the desired temperature drift of a circuit can be easily achieved, in a simple manner by the inventive circuit and method.

Moreover, it is advantageous that the method can be carried out in a circuit exclusively using current sources, or exclusively using current sinks, or a combination of at least one current source and at least one current sink. For simplicity and ease of description and understanding, most of the following embodiments described in detail herein generally relate to examples using only current sinks, but the same principles pertain to circuits using current sources instead of current sinks.

In a further development and particular embodiment of the inventive method, the current of the first current sink is summed or added with the current of the second current sink, whereby the temperature coefficient of the resulting output current of the overall circuit arrangement takes on values in a range, of which the lower limit is determined by the temperature coefficient of the current of the first current sink and the upper limit is determined by the temperature coefficient of the current of the second current sink. Generally, in another embodiment feature of the invention in which the two internal currents are added together, the resulting temperature coefficient of the output current results as the sum of the two temperature coefficients of the two internal currents.

In a different embodiment of the inventive method, in which the resulting temperature coefficient of the resulting output current of the circuit arrangement is to be greater than the temperature coefficient of the first current sink in the circuit arrangement, the resulting overall temperature coefficient is fixed or specified by subtracting the current of the first current sink from the current of the second current sink. In this context, it is especially advantageous if the current of the second current sink is independent of the temperature, i.e. exhibits a temperature coefficient of essentially zero, i.e. negligibly close to zero.

In yet another embodiment of the inventive method, in order to fix a negative temperature coefficient of the overall output current of the current supply circuit, the current of the second current sink is subtracted from the current of the first current sink. In this context, it is advantageous if the temperature coefficient of the current of the second current sink is arbitrarily small.

Further experiments conducted by the present applicant have shown that it is advantageous to carry out the subtraction of the respective currents of the first and second current sinks by means of a current mirror. Also as mentioned above, experiments conducted by the present applicant have shown that the method can be carried out using a combination of current sinks and current sources, as well as using exclusively combinations of current sinks. While the current sinks are preferably connected to a ground potential, in distinction thereto, the current sources are preferably connected with a supply voltage. By using current sources in the current supply circuit arrangement, a consumer connected to the output of the current supply circuit arrangement can be provided with its required current. On the other hand, if the circuit arrangement uses current sinks rather than current sources, then the circuit arrangement will actually draw in the respective current at its circuit output, i.e. effectively providing a negative current at the circuit output. Both of these types of circuits are generally called a current supply circuit arrangement herein.

### BRIEF DESCRIPTION OF THE DRAWINGS

In order that the invention may be clearly understood, it will now be described in detail in connection with example embodiments thereof, with reference to the accompanying drawings, wherein:

FIG. 1 is a schematic block diagram of a first embodiment of a current supply circuit arrangement according to the invention, of which an overall output current is formed by coupling the respective internal currents of a first current sink and a second current sink in a coupling element;

FIG. 2A is a block circuit diagram showing somewhat more detail than FIG. 1, for a particular embodiment of a current supply circuit arrangement in which the current of the first current sink is summed or added with the current of the second current sink;

FIG. 2B is a schematic graph of current versus temperature, to illustrate the temperature dependence of the output current of the current supply circuit arrangement according to FIG. 2A;

FIG. 2C is another current-temperature diagram showing an example of a different temperature dependence of the output current of a circuit according to FIG. 2A;

FIG. 2D is yet another current-temperature diagram showing still a further example of a different temperature dependence of the output current of a current supply circuit arrangement embodied according to FIG. 2A;

FIG. 3A is a block circuit diagram generally similar to FIG. 2A, but showing a further embodiment of a current supply circuit arrangement in which the overall output current is formed by subtraction between the current of the first current sink and the current of the second current sink;

FIG. 3B is a current-temperature diagram showing the temperature dependence of a first example of the output current of a circuit arrangement embodied according to FIG. 3A;

FIG. 3C is another current-temperature diagram showing a further example of the temperature dependence of the output current of a circuit arrangement embodied according to FIG. 3A;

FIG. 3D is a current-temperature diagram showing still a further possible example of the temperature dependence of the output current of a circuit embodied according to FIG. 3A;

FIG. 3E is a current-temperature diagram showing another example of a possible temperature dependence of the output current of a circuit embodied according to FIG. 3A:

FIG. 4 is a block circuit diagram of an example of a circuit arrangement using bipolar transistors for the current sinks in a general circuit according to FIG. 3A;

FIG. 5 is a block circuit diagram of an example of a circuit arrangement using MOS transistors for the current sinks in a general circuit according to FIG. 3A; and

FIG. 6 is a block circuit diagram of an example of a circuit arrangement using bipolar transistors embodying current sources in a further embodiment of the present invention.

### DETAILED DESCRIPTION OF A PREFERRED EXAMPLE EMBODIMENT AND OF THE BEST MODE OF THE INVENTION

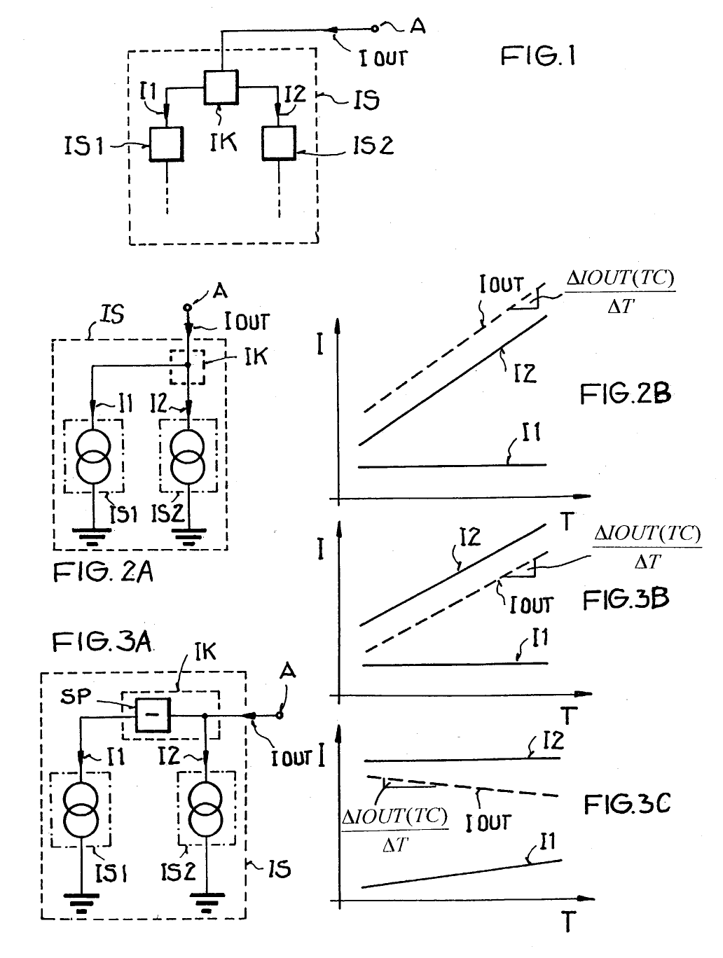

As shown in FIG. 1, an embodiment of a current supply circuit arrangement IS according to the invention is embodied particularly as a current sink circuit IS, which draws a current IOUT at a current output A. The current sink circuit IS includes an internal first current sink IS1 and an internal second current sink IS2 as well as a coupling element IK that is connected to both current sinks IS1 and IS2 and to the output A of the current sink circuit IS. By coupling or combining a first internal current I1 of the first current sink IS1 with a second internal current I2 of the second current sink IS2, the coupling element IK produces and provides the overall output current IOUT being drawn at the output A of the current sink circuit IS. Thereby, the overall output current IOUT has a resulting temperature coefficient TC that is determined by the combination of the respective temperature coefficients of the first internal current I1 and the second internal current I2 of the first and second current sinks IS1, IS2. The magnitude of the resulting output current IOUT and the temperature coefficient TC thereof are further determined by the particular manner of coupling the first internal current I1 with the second internal current I2, and by the respective magnitude as well as the magnitude ratio of the first internal current I1 relative to the second internal current I2.

A significant advantage of the circuit arrangement and the associated method according to the invention, is that it is easy to set a desired temperature coefficient TC of the output current IOUT in an economical manner, whereby the temperature coefficient may also be easily adapted to the requirements of an external circuit arrangement that is connected to the output A of the current supply circuit arrangement IS. While the current supply circuit arrangement IS involves current sinks in the present embodiment, it can also be carried out according to the invention with current sources (see e.g. FIG. 6 discussed below), so that the output A actively supplies a positive outflowing current to supply the current consumption needs of the external circuit arrangement connected to the output A.

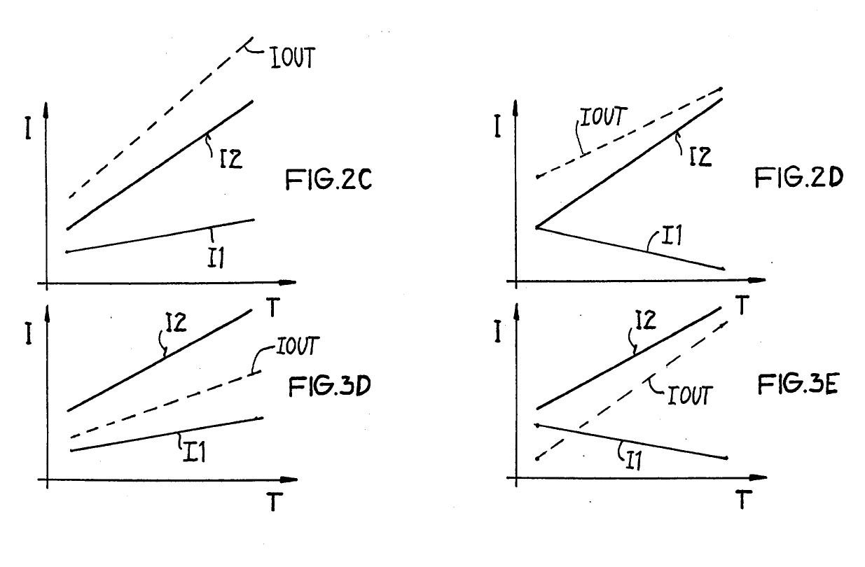

FIG. 2A shows one possible example embodiment for carrying out the general schematic circuit according to FIG. 1. In the arrangement according to FIG. 2A, the coupling element IK is a current adding or summing element, which sums or adds together the first internal current I1 of the first current sink IS1 with the second internal current I2 of the second current sink IS2, so as to thereby form the output current IOUT of the current supply circuit IS having the resulting combined temperature coefficient TC. For this purpose, both current sinks IS1 and IS2 are respectively connected to the coupling element IK and also to a reference potential, e.g. ground. If the two internal currents I1 and I2 are to be entirely summed together, then the coupling element IK may be a simple connection or junction node, whereby the two current sinks IS1 and IS2 are connected directly together. With this manner of coupling, the resultant temperature coefficient TC of the output current IOUT will be set at a value between zero, i.e. no temperature dependence of the output current IOUT, and a combined value of the temperature coefficients of the internal currents I1 and I2.

FIG. 2B is a current (I) versus temperature (T) diagram schematically representing one example of the temperature dependent variation of the output current IOUT with respect to temperature T, relative to the temperature dependent variation of the two internal currents I1 and I2. In this example, the output current IOUT is formed as the sum of the two internal currents I1 and I2. Consequently, the temperature coefficient TC of the output current IOUT also results as a combination of the temperature coefficients of the two internal currents I1 and I2. Particularly, in this example, by selecting a very small temperature coefficient for the first internal current I1, i.e. a temperature coefficient of approximately zero or negligibly close to zero so that the current I1 is essentially independent of temperature, the resultant temperature coefficient TC of the overall output current IOUT will (in relative terms) be smaller than the temperature coefficient of the second internal current I2, with a current magnitude offset based on the current magnitude of the first internal current I1. In other words, in the I vs. T diagram of FIG. 2B, the variation of the output current IOUT relative to temperature T will have the same slope as the second internal current I2, but the relative temperature coefficient TC of the output current IOUT will be smaller than the temperature coefficient of I2, because IOUT has a larger current magnitude than I2 at any given temperature. Particularly the current magnitude of the output current IOUT at any given temperature T, will be equal to the magnitude of the first current I1 plus the magnitude of the second current I2 at that given temperature T. Thus, the relative temperature dependence of the current (relative to the absolute current magnitude) is smaller for the larger-magnitude current IOUT than for the smaller-magnitude current I2, when both currents IOUT and I2 have the same ΔI/T slope in the I vs. T diagram.

The resulting temperature coefficient TC will be determined by the combination of the temperature coefficients of the two currents I1 and I2, so that the resulting temperature coefficient TC depends on the relationship of the temperature coefficients of the two currents I1 and I2 to each other. While FIG. 2B shows the simple case in which the temperature coefficient of the first current I1 is essentially zero, FIGS. 2C and 2D represent situations in which the first current I1 has a positive temperature coefficient and a negative temperature coefficient respectively. The slope steepness of the curve or line of the first current I1 in each of these two cases is less than that of the second current I2, and has a corresponding influence on the overall resulting temperature coefficient TC of the output current IOUT.

In each respective case illustrated in the drawings, the temperature coefficient is based on a single constant value arising from the slope of a line representing a linear temperature dependence of the current relative to temperature. It should also be understood that the temperature coefficient need not be a fixed coefficient value, but rather could be a temperature dependency function that defines a non-linear temperature dependence of the current. In other words, the equation defining the temperature dependence of the current with respect to temperature does not need to be a linear equation, but rather could be any other functional relationship. Such non-linear temperature dependency functions are also to be understood within the scope of the term “temperature coefficient” herein. In any event, for the simple case of a linear temperature dependence, the current can be defined by the following function or equation:

I(T2)=I(T1)*(1+TCI*ΔT)

wherein T1 represents a first temperature, T2 represents a second temperature that may be greater than or less than T1, ΔT represents the difference between the temperatures T2 and T1, and TCI represents the temperature coefficient of the current I. The unit of TCI is reciprocal temperature, e.g. 1/K or K⁻¹, to represent a proportional or relative variation (e.g. as a percentage of magnitude) of the current versus temperature.

Considering the further relationship:

n=I2(T1)/I1>1

wherein the current I1 of the first current sink is independent of temperature (i.e. constant for all temperatures), and less than the current I2 of the current sink IS2, then the output current IOUT formed by summing together the two currents I1 and I2 is given by:

IOUT(T2)=I2(T1)*(1+1/n)*{1+(n/(n+1))TC2*ΔT}

With a current sink IS2, of which the temperature coefficient TC is proportional to the absolute temperature (PTAT—Proportional To Absolute Temperature current source), values of the temperature coefficient TC between 0 and 3.3*10e−3 can be achieved.

The above examples represent the simplest case in which the coupling element IK is a direct junction to achieve a total adding or summing of the two currents I1 and I2. On the other hand, for carrying out only a partial or fractional addition or summing of the first current I1 with the second current I2, the coupling element or node IK would be embodied as a suitable electronic circuit for summing together only a portion of one or both currents. The functional dependence of the temperature coefficient TC is not changed thereby. Namely, the temperature coefficient TC would still be determined as a corresponding proportional combination of the temperature coefficients of the two internal currents.

FIG. 3A schematically represents a further example embodiment of the internal construction of the current sink circuit IS. In this embodiment, the coupling element IK carries out a subtraction between the two internal currents I1 and I2. Except for this difference of the coupling element IK, the circuit of FIG. 3A, e.g. the connections between the circuit blocks within the circuit IS, are identical to the circuit arrangement according to FIG. 2A. The functional operation of the present embodiment of the circuit IS with the coupling element IK carrying out a subtraction will now be described.

The coupling element IK subtracts the first internal current I1 of the first current sink IS1 from the second internal current I2 of the second current sink IS2. The resulting overall temperature coefficient TC of the output current IOUT is determined by the relationship of the values of the temperature coefficients of the two currents I1 and I2, which are subtracted from one another. Also, the magnitude of the output current IOUT is determined by the magnitude relationship of the current I1 relative to the current I2, dependent on the temperature according to the temperature coefficient.

FIGS. 3B, 3C, 3D and 3E show different examples of the possible output current IOUT and its temperature coefficient TC that can be achieved with the subtracting circuit IS according to FIG. 3A. Experiments carried out by the present applicant have shown that the examples represented in FIGS. 3B and 3C are especially advantageous for increasing the desired temperature coefficient TC and changing the sign of the desired temperature coefficient by combination of the temperature coefficients of the two internal currents I1 and I2, respectively.

In the first case, illustrated in FIG. 3B, the first internal current I1 has a temperature coefficient of essentially zero or negligibly close to zero, i.e. essentially no temperature dependence, while the second internal current I2 has a positive temperature coefficient, i.e. increasing current magnitude for increasing temperature with a linear relationship. Also, the magnitude of the current I1 is less than the magnitude of the current I2 for all temperatures of interest. By subtracting the current I1 from the current I2, the resulting magnitude of the output current IOUT will be between the magnitudes of the two internal currents I1 and I2. Also, the temperature coefficient of the output current IOUT will, relative to absolute magnitude, be higher than the temperature coefficient of the second internal current I2, with a negative current magnitude offset relative to the current I2 based on the subtraction of the current magnitude of the current I1.

In the second case shown in FIG. 3C, the second internal current I2 has a temperature coefficient of essentially zero, i.e. essentially no dependence on temperature, while the first internal current I1 has a positive temperature coefficient. Also, the magnitude of the current I1 is less than the magnitude of the current I2 for all temperatures of interest. By subtracting this first internal current I1 from this second internal current I2, the result is an output current IOUT having a negative temperature coefficient TC. Also, the magnitude of the output current IOUT will be between the magnitudes of the currents I1 and I2, with the temperature-dependent magnitude of the current I1 leading to a corresponding negative current magnitude offset of the output current IOUT relative to the second internal current I2 at each given temperature. In other words, the output current IOUT will have a magnitude below that of the second internal current I2 by an amount defined by the magnitude of the first internal current I1 at any given temperature. It is significant to note that this circuit IS, with a subtracting coupling element IK, has effectively converted a positive temperature coefficient of the internal current I1 to a negative temperature coefficient of the output current IOUT, while also achieving an output current magnitude between that of the two internal currents.

FIGS. 3D and 3E represent cases in which both the first and second internal currents I1 and I2 are temperature dependent. Namely, the second internal current I2 has a positive temperature coefficient in both cases, while the first internal current I1 has a positive temperature coefficient in FIG. 3D and a negative temperature coefficient in FIG. 3E. In FIG. 3D, the subtraction of the current I1 from the current I2 results in an output current IOUT with a current magnitude between the currents I1 and I2, and an increased (magnitude relative) temperature coefficient TC based on the temperature coefficient of the current I2. Note that if the temperature coefficient of the current I1 was selected more positive than the temperature coefficient of the current I2 (FIG. 3C), then the resulting temperature coefficient of the output current IOUT would actually be negative. In FIG. 3E, since the current I1 has a negative temperature coefficient and is subtracted from the current I2, the resulting slope of the combined output current IOUT actually becomes more positive (i.e. with a higher positive value) than that of the internal current I2, but the temperature coefficient TC must be evaluated relative to the current magnitude.

The above examples of FIGS. 2B, 2C, 2D, 3B, 3C, 3D and 3E demonstrate that it is simple to achieve a desired output current IOUT having a desired current magnitude range as well as a desired positive or negative temperature coefficient, by providing or selecting the suitable current magnitude and temperature dependence of the two internal current sinks IS1 and IS2, and either an addition or subtraction function for the coupling element IK. The illustrated examples are not exhaustive, but merely representative of the wide range of resulting output currents that can be achieved in this simple manner. It is a substantial advantage of the circuit arrangement and method according to the invention, that it is possible to achieve a negative temperature coefficient for the output current IOUT by carrying out a subtraction of the two internal currents relative to each other, whereby the internal currents may have any desired positive temperature coefficients. In this context, the temperature coefficient TC of the output current IOUT can be set as desired in a range between the largest positive temperature coefficient of the internal currents I1 and I2 and the negative value of the largest positive temperature coefficient of the currents I1 and I2, by appropriately selecting or dimensioning the currents I1 and I2 produced by the current sinks IS1 and IS2, as well as the temperature coefficients thereof.

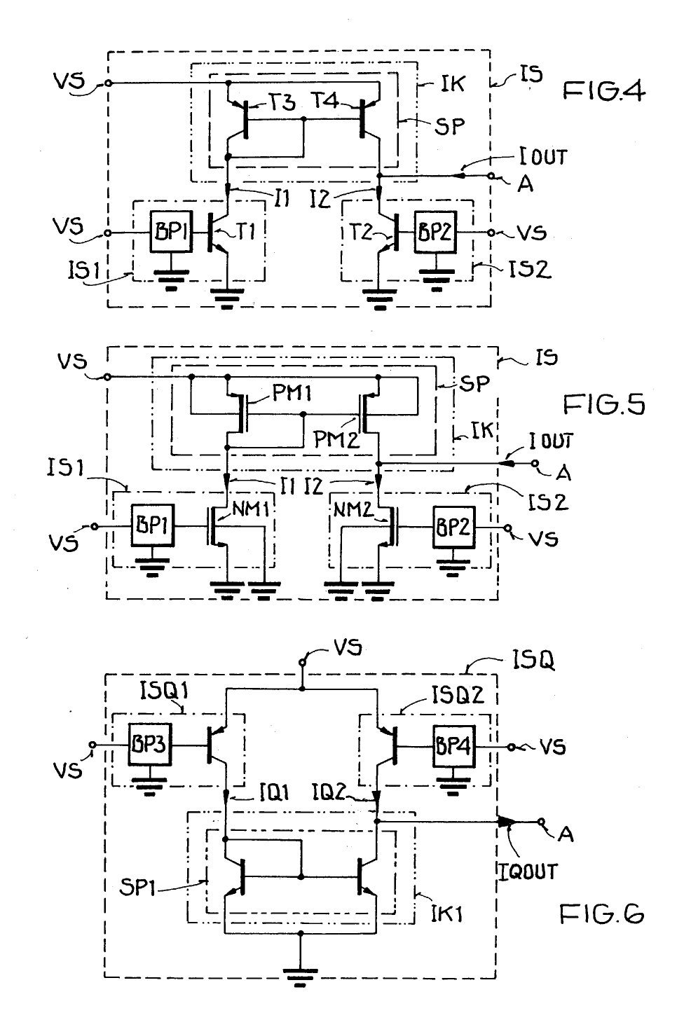

FIG. 4 schematically represents a particular embodiment of a current sink circuit IS in accordance with the general circuit schematic of FIG. 3A as discussed above. The current sink circuit IS draws the output current IOUT at the output A, whereby the output current IOUT is formed by the coupling element IK by subtracting the internal current I1 from the internal current I2. The general circuit blocks shown and discussed above in connection with FIG. 3A are now illustrated and explained in greater detail in connection with a particular example embodiment shown in FIG. 4.

The first internal current sink IS1 comprises a bipolar NPN transistor T1 in a grounded emitter circuit, as well as a band gap circuit BP1 that is connected with a supply voltage VS and with a reference potential, e.g. ground. Furthermore, the emitter of this transistor T1 is connected to the reference potential, e.g. ground, and the base of the transistor T1 is connected with the band gap circuit BP1. The collector of this transistor T1 is connected with the coupling element IK, which is particularly embodied as a current mirror circuit SP.

The current mirror circuit SP embodying the coupling element IK comprises a bipolar PNP transistor T3 and another bipolar PNP transistor T4. The collector of the transistor T1 of the first current sink IS1 is connected with the collector and the base of the transistor T3, which is thereby connected in a diode circuit arrangement, in the current mirror SP. The emitter of this transistor T3 is connected with the supply voltage VS and with the emitter of the second transistor T4 of the current mirror circuit SP. The base of the transistor T3 is further connected to the base of the transistor T4, while the collector of the transistor T4 is connected to the second internal current sink IS2 and to the output A of the current sink circuit IS.

The second internal current sink IS2 has a construction generally similar to that of the first internal current sink IS1. Thus, the second internal current sink IS2 comprises a bipolar NPN transistor T2 in a grounded emitter circuit, as well as a band gap circuit BP2 that is connected to the supply voltage VS and the reference potential such as ground. Furthermore, the emitter of the transistor T2 is connected with the reference potential, while the base of the transistor T2 is connected with the band gap circuit BP2. The collector of the transistor T2 is connected with the coupling element IK, particularly with the collector of the transistor T4 in the current mirror circuit SP.

Next, the functional operation of the circuit arrangement according to FIG. 4 will be explained. The base of the transistor T1 is energized with a constant voltage by the band gap circuit BP1. As a result, the transistor T1 draws the current I1 at its collector, and this current I1 is duplicated and reflected via the current mirror SP to the collector of the transistor T2 of the second internal current sink IS2. Meanwhile, the base of the transistor T2 is energized with a constant voltage from the band gap circuit BP2, so as to draw the current I2 at the collector of the transistor T2. As a result of this connection and operation, the reflected current I1 is effectively subtracted from the current I2 at the output A of the current sink circuit IS. Namely, what will appear at the output A of the current sink circuit IS is only the difference between the first internal current I1 and the second internal current I2, as a resulting output current IOUT being drawn into the output A of the circuit IS. In this context, the temperature coefficient TC of the output current IOUT is determined from the temperature coefficients of the internal currents I1 and I2, for example in any one of the manners discussed above in connection with FIGS. 3A, 3B, 3C, 3D and/or 3E.

FIG. 5 illustrates a further embodiment of a circuit arrangement IS that functions in the same manner as the circuit described above in connection with FIG. 4. The main difference is that the circuit arrangement according to FIG. 5 uses MOS transistors instead of the bipolar transistors of the circuit of FIG. 4. Particularly, the NPN transistors T1 and T2 of the circuit of FIG. 4 are respectively replaced by NMOS transistors NM1 and NM2 in the circuit of FIG. 5, while the PNP transistors T3 and T4 of FIG. 4 have been replaced with PMOS transistors PM1 and PM2 in FIG. 5. The respective source terminals of the MOS transistors are connected with the body terminals thereof.

Still another example embodiment of a current supply circuit according to the invention, and particularly a current source circuit ISQ, is shown in FIG. 6. Instead of internal current sinks like the circuits discussed above, the present current source circuit ISQ uses two internal current sources ISQ1 and ISQ2. To provide the output current IQOUT of the current source circuit ISQ, a first internal current IQ1 of the first internal current source ISQ1 is subtracted from a second internal current IQ2 of the second internal current source ISQ2, which also correspondingly determines the temperature coefficient TC of the output current IQOUT based on the subtraction of the temperature coefficients of the internal currents. To achieve this, the internal current sources ISQ1 and ISQ2 are connected with a coupling element IK1 that is embodied as a current mirror circuit SP1.

The internal current sources ISQ1 and ISQ2 are embodied with bipolar transistors, and further comprise respective band gap circuits BP1 and BP2 which are each connected to the reference potential such as ground and a supply voltage VS. In the current source ISQ1, the transistor that supplies the internal current IQ1 is activated by the band gap circuit BP3, while the transistor that supplies the current IQ2 in the current source ISQ2 is actuated by the band gap circuit BP4. In comparison to the circuit blocks IS1, IS2 and SP in the circuit according to FIG. 4, the respective circuit blocks ISQ1, ISQ2 and SP1 of the circuit of FIG. 6 are embodied with transistors of the respective complementary types. Namely, the PNP transistors of the circuit of FIG. 4 have been replaced with NPN transistors in FIG. 6, while the NPN transistors of FIG. 4 have been replaced with PNP transistors in FIG. 6. The general functions of the individual circuit blocks ISQ1, ISQ2, and SP1 in FIG. 6 correspond to the functions of the circuit blocks IS1, IS2 and SP in FIG. 4, except that the present circuit involves current sources rather than current sinks.

In this circuit of FIG. 6, the internal current IQ1 is subtracted from the internal current IQ2 through the current mirror SP1, to provide the output current IQOUT. Thereby, the magnitude and the temperature coefficient TC of the output current IQOUT are determined dependent on the magnitudes and the temperature coefficients of the respective currents IQ1 and IQ2 of the internal current sources ISQ1 and ISQ2, in a range between the largest positive temperature coefficient of the current IQ1 and IQ2 and the negative value of the largest positive temperature coefficient of the currents IQ1 and IQ2.

Although the invention has been described with reference to specific example embodiments, it will be appreciated that it is intended to cover all modifications and equivalents within the scope of the appended claims. It should also be understood that the present disclosure includes all possible combinations of any individual features recited in any of the appended claims.

What is claimed is:

1. A current supply circuit for producing an output current having a selected output temperature coefficient defining a variation of said output current dependent on temperature, said circuit comprising:
a first current sink or source having a first current terminal that produces a first internal current having a first temperature coefficient;
a second current sink or source having a second current terminal that produces a second internal current having a second temperature coefficient; and
a current coupling element that has a first input connected to said first current terminal of said first current sink or source, a second input connected to said second current terminal of said second current sink or source, and an output connected to a circuit output of said circuit;
wherein said current coupling element couples and combines said first internal current and said second internal current to produce said output current at said circuit output.

2. The current supply circuit according to claim 1, wherein said first current sink or source is a first current sink that draws in said first internal current at said first current terminal, and said second current sink or source is second current sink that draws in said second internal current at said second current terminal.

3. The current supply circuit according to claim 2, wherein each one of said current sinks respectively comprise a band gap circuit and a transistor with a base or gate connected to said band gap circuit.

4. The current supply circuit according to claim 1, wherein said first current sink or source is a first current source that feeds out said first internal current at said first current terminal, and said second current sink or source is a second current source that feeds out said second internal current at said second current terminal.

5. The current supply circuit according to claim 1, wherein said current coupling element comprises a direct junction of said first input and said second input to said output of said current coupling element, so as to sum together said first internal current and said second internal current to produce said output current.

6. The current supply circuit according to claim 1, wherein said current coupling element comprises a current mirror that subtracts one of said internal currents from another of said internal currents to produce said output current.

7. The current supply circuit according to claim 1, wherein said first temperature coefficient is a first non-negative temperature coefficient and said second temperature coefficient is a second non-negative temperature coefficient.

8. The current supply circuit according to claim 7, wherein said output temperature coefficient is a negative temperature coefficient.

9. The current supply circuit according to claim 7, wherein one of said first and second temperature coefficients is equal to zero or negligibly close to zero, and another of said first and second temperature coefficients is a positive temperature coefficient.

10. The current supply circuit according to claim 1, expressly excluding a current mixer connected to a control voltage.

11. A method of producing an output current having a selected output temperature coefficient defining a variation of said output current dependent on temperature, comprising the steps:
a) producing a first internal current having a first temperature coefficient by a first current sink or source;
b) producing a second internal current having a second temperature coefficient by a second current sink or source, wherein said second temperature coefficient is different from said first temperature coefficient and/or a first magnitude of said first internal current is different from a second magnitude of said second internal current; and
c) adding or subtracting one of said internal currents relative to another of said internal currents, to produce said output current.

12. The method according to claim 11, wherein said step a) comprises producing said first internal current by said first current sink, and said step b) comprises producing said second internal current by said second current sink.

13. The method according to claim 11, wherein said step a) comprises producing said first internal current by said first current source, and said step b) comprises producing said second internal current by said second current source.

14. The method according to claim 11, wherein said step c) comprises adding together said first and second internal currents to produce said output current, and wherein said output temperature coefficient is a combination of said first and second temperature coefficients.

15. The method according to claim 14, wherein said first and second temperature coefficients both have the same sign, and said output temperature coefficient has a lower magnitude than each one of said first and second temperature coefficients.

16. The method according to claim 11, wherein said step c) comprises adding together said first and second internal currents to produce said output current, and wherein said output temperature coefficient has a value in a range from said first temperature coefficient to said second temperature coefficient.

17. The method according to claim 11, wherein said step c) comprises subtracting said first internal current from said second internal current, and wherein said output temperature coefficient is determined by said subtracting.

18. The method according to claim 17, wherein said first temperature coefficient is negative and said second temperature coefficient is non-negative, and wherein said output temperature coefficient is positive and greater than both of said first and second temperature coefficients.

19. The method according to claim 17, wherein both of said first and second temperature coefficients are non-negative, and said output temperature coefficient is negative.

20. The method according to claim 17, wherein said step c) uses a current mirror circuit to carry out said subtracting.

21. The method according to claim 11, wherein one of said first and second temperature coefficients is equal or negligibly close to zero.

22. The method according to claim 21, wherein another of said first and second temperature coefficients is positive.

23. The method according to claim 11, wherein both of said first and second temperature coefficients have the same sign.

24. The method according to claim 11, wherein both of said first and second temperature coefficients are positive.
